(19) United States
(12) Patent Application Publication
(10) Pub. No.: US 2007/0186282 A1
(43) Pub. Date: Aug. 9, 2007

(54) Techniques for identifying and managing potentially harmful web traffic

(75) Inventor: James D. Jenkins, Everett, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/347,966

(22) Filed: Feb. 6, 2006

(51) Int. Cl. G06F 12/14

(52) U.S. Cl. 726/22

(57) ABSTRACT

Techniques are provided for identifying a potentially harmful request. A threat rating is assigned to a received request in accordance with one or more attribute values of the received request. An action is determined in accordance with the threat rating.

### BACKGROUND

Internet servers accept requests issued by users or clients. One problem experienced today by the servers is the possibility of harmful requests. A request may be, intentionally or unintentionally, one that is malformed and may cause security problems for the server system. Regardless of whether a request is malformed, requests may also cause problems if the number of requests received by the server system within a time period may be so large that the server system is oversaturated. For example, an attacker may write a script or program that submits thousands of requests per second to a web server. The large volume of incoming requests may cause the web server to be rendered non-functional and unable to provide any services.

For many web-based server systems, a countermeasure has been to block requests from the particular Internet Protocol (IP) address of the offending user computer. An existing server may accomplish this by having the server'firewall block any incoming requests from the particular IP address. The foregoing has drawbacks in that the blocking countermeasure of the firewall filters out all requests from a particular IP address which may not always be desirable. For example, this countermeasure may potentially block out all requests from a proxy server. Furthermore, the foregoing countermeasure may be inadequate in the event that the large volume of requests is sent in a distributed fashion from multiple IP addresses.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are provided for identifying a potentially harmful request. A threat rating is assigned to a received request in accordance with one or more attribute values of the received request. An action is determined in accordance with the threat rating.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a user computer for use in connection with performing the techniques described herein;

FIGS. 3 and 4 are examples of components that may be included in embodiments of the server system;

FIG. 5 is an example of an embodiment of an incoming request;

FIG. 6 is an example of an embodiment of a threat profile;

FIG. 7 is an example of an embodiment of a threat matrix of countermeasures;

FIG. 8 is an example illustrating components that may be included in a request analyzer of FIGS. 3 and 4; and

FIG. 9 is a flowchart of processing steps that may be performed in an embodiment in connection with the techniques described herein.

### DETAILED DESCRIPTION

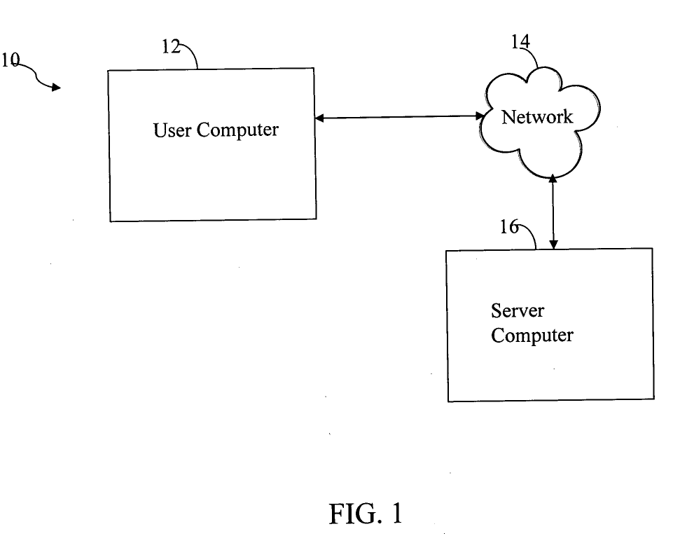

Referring now to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 is a user computer 12, a network 14, and a server computer 16. The user computer 12 may include a standard, commercially-available computer or a special-purpose computer that may be used to execute one or more program modules. Described in more detail elsewhere herein are program modules that may be executed by the user computer 12 in connection with the techniques described herein. The user computer 12 may operate in a networked environment and communicate with the server computer 16 and other computers not shown in FIG. 1.

It will be appreciated by those skilled in the art that although the user computer is shown in the example as communicating in a networked environment, the user computer 12 may communicate with other components utilizing different communication mediums. For example, the user computer 12 may communicate with one or more components utilizing a network connection, and/or other type of link known in the art including, but not limited to, the Internet, an intranet, or other wireless and/or hardwired connection(s).

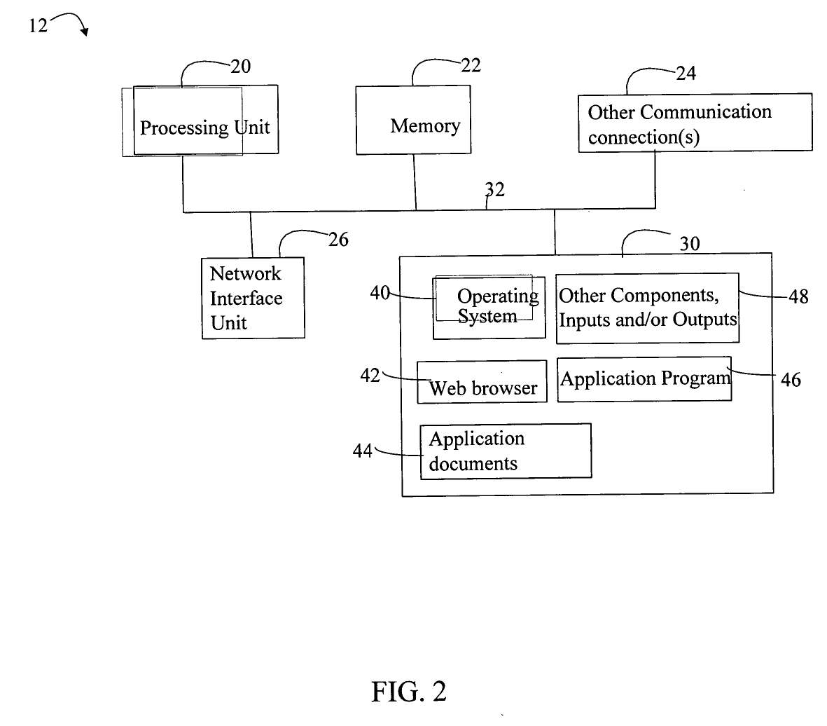

Referring now to FIG. 2, shown is an example of components that may be included in a user computer 12 as may be used in connection with performing the various embodiments of the techniques described herein. The user computer 12 may include one or more processing units 20, memory 22, a network interface unit 26, storage 30, one or more other communication connections 24, and a system bus 32 used to facilitate communications between the components of the computer 12.

Depending on the configuration and type of user computer 12, memory 22 may be volatile (such as RAM), non-volatile (such as ROM, flash memory, etc.) or some combination of the two. Additionally, the user computer 12 may also have additional features/functionality. For example, the user computer 12 may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the user computer 12. The storage 30 in one embodiment may be a mass-storage device with associated computer-readable media providing non-volatile storage for the user computer 12. Although the description of computer-readable media as illustrated in this example may refer to a mass storage device, such as a hard disk or CD-ROM drive, it will be appreciated by those skilled in the art that the computer-readable media can be any available media that can be accessed by the user computer 12.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by user computer 12. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The user computer 12 may also contain communications connection(s) 24 that allow the user computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media.

In one embodiment, the user computer 12 may operate in a networked environment as illustrated in FIG. 1 using logical connections to remote computers through a network. The user computer 12 may connect to the network 14 of FIG. 1 through a network interface unit 26 connected to bus 32. The network interface unit 26 may also be utilized in connection with other types of networks and/or remote systems and components.

One or more program modules and/or data files may be included in storage 30. During operation of the user computer 12, one or more of these elements included in the storage 30 may also reside in a portion of memory 22, such as, for example, RAM for controlling the operation of the user computer 12. The example of FIG. 2 illustrates various components including an operating system 40, a web browser 42, one or more application documents 44, one or more application programs 46, and other components, inputs, and/or outputs 48. The operating system 40 may be any one of a variety of commercially available or proprietary operating system. The operating system 40, for example, may be loaded into memory in connection with controlling operation of the user computer. One or more application programs 46 may execute in the user computer 12 in connection with performing user tasks and operations. The application programs 46 may utilize one or more application documents 44 and possibly other data in accordance with the particular application program.

The user computer 12, via the web browser 42, may issue a request to the server system 16. Such requests can be potentially harmful to the server system in a variety of different ways. The requests may be sent, for example, from a single malicious user on a single user system, from multiple user computers as part of a distributed attack, and the like. The requests may be generated in a variety of different ways such as, for example, by code executing on the user computer which may be characterized as spyware, a virus, or other malicious code. In one aspect, the request may be malformed and may cause harm if the receiving server system attempts to process such received malformed requests. In accordance with another aspect, a large volume of requests may be sent to a server system as part of a distributed attack on the server system. The requests may be of such a large volume within a time period that the server system may be saturated and unable to process any requests thereby rendering the server system non-functional. As such processing may be performed by the server system 16 in connection with identifying and managing potentially harmful web traffic. More details of the server system 16 are described in following paragraphs.

What will be described in following paragraphs are techniques that may be used in connection with the server system to monitor each incoming request. The techniques determine if the request, in isolation and in the context of other received incoming requests, is potentially harmful. The server system can take appropriate action in accordance with the assessed threat or level of harm for the particular incoming request.

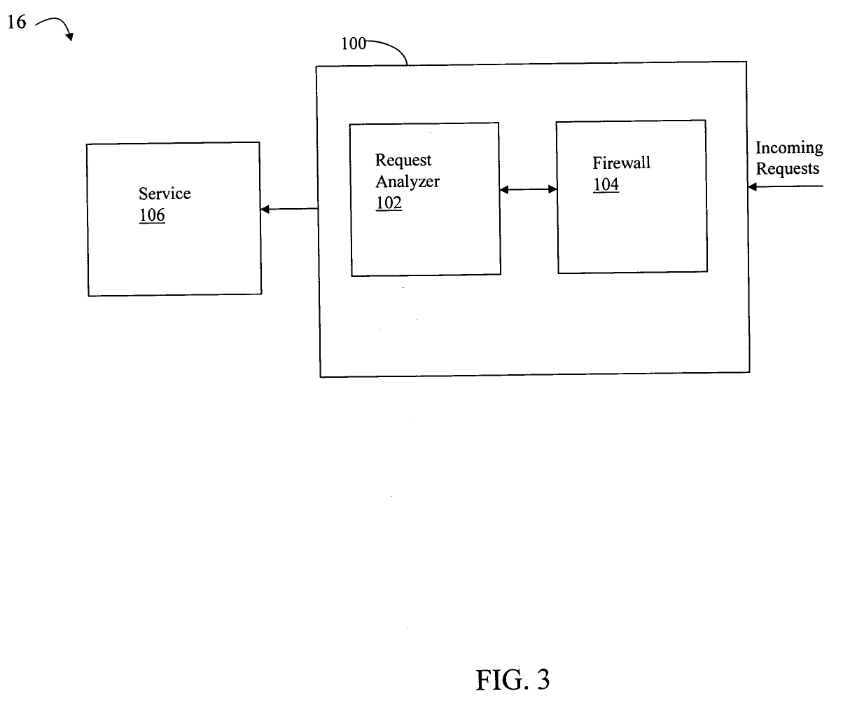

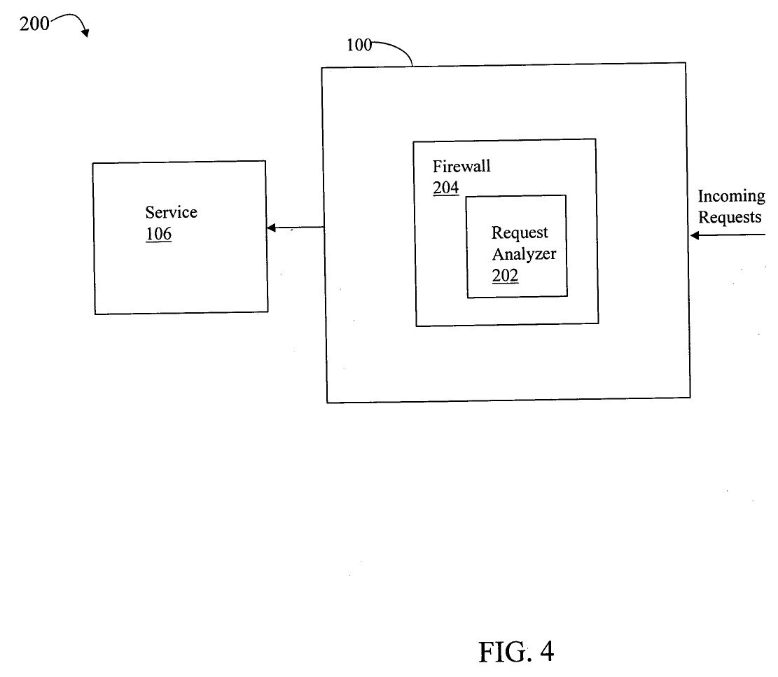

Referring now to FIGS. 3 and 4, shown are examples of components that may be included in embodiments of the server system. It should be noted that the server system 16 may include a processing unit, memory, communication connections, and the like as also illustrated in connection with the user computer 12. What is described and illustrated in FIGS. 3 and 4 are some of those components that may be included in the storage 30 of the server computer 16 in connection with the techniques described herein. Other components may be included in an embodiment of the server computer 16 and, as will be appreciated by those skilled in the art, are also necessary in order for the server computer 16 to operate and perform tasks. Such other components have been omitted from FIGS. 3 and 4 for the sake of simplicity in describing the techniques for management and analysis of incoming requests.

FIG. 3 includes a request receiving component 100 and a service 106. The request receiving component 100 may perform processing on incoming requests received by the server computer. The incoming requests may be requests for the server computer to perform a particular service, such as by service 106. The service 106 may be, for example, an e-mail service, a search engine which processes query requests, and the like. The particular service may vary with embodiment. One or more services of the same or different type may be performed by an embodiment of the server computer 16. In this example the component 100 includes a firewall 104 and a request analyzer 102. The firewall 104 may interact with the request analyzer 102 in connection with processing a request. The firewall 104 may perform certain processing on the user request and may accordingly allow the request to pass through to the request analyzer 102. The request analyzer 102 may perform processing described in more detail in follow paragraphs which assigns a threat rating to the incoming request. The request analyzer may also determine a particular action to take in accordance with the assigned threat rating. The request analyzer may, for example, pass the request on through to the service 106 for servicing if the request analyzer determines no threat is associated with the incoming. Alternatively, the request analyzer may determine that a countermeasure is to be performed in accordance with the assigned threat rating. The countermeasure may be any one of a variety of different actions which is described in more detail in following paragraphs. In connection with performing the countermeasure, the request analyzer may interact with the firewall and/or other components. For example, if the request analyzer determines that the request is to be blocked, the request analyzer may communicate with the firewall to proceed with blocking the request.

Referring now to FIG. 4, shown is an example of another embodiment of components that may be included in the server computer 16. In the example 200, the component 100 is illustrated as including the request analyzer 202 functionally within the firewall 204. This is in contrast to the embodiment of FIG. 3 in which the request analyzer 102 is illustrated as a separate component. The functionality described herein in connection with the request analyzer may be embodied as a separate component, as illustrated in connection with element 102 of FIG. 3, or alternatively within another component such as the firewall 204 of FIG. 4.

The techniques described herein analyze attributes of an incoming request and assigning a threat rating to the incoming request. As part of the processing of assigning the threat rating, one or more attributes and associated attribute values of the incoming request are compared to information included in one or more threat profiles. Threat profiles may be characterized as including profile information about potentially harmful requests. Threat profiles also include a metric or threat rating for one or more attributes and one or more associated values. A threat rating for the incoming request is determined and then a threat matrix is used to determine an action to be accordingly taken based on the threat rating. The action may range from, for example, performing the request without monitoring or auditing (e.g., no perceived threat) to blocking the request (e.g., assessed threat level is high and harm is certain). The foregoing is described in more detail in following paragraphs.

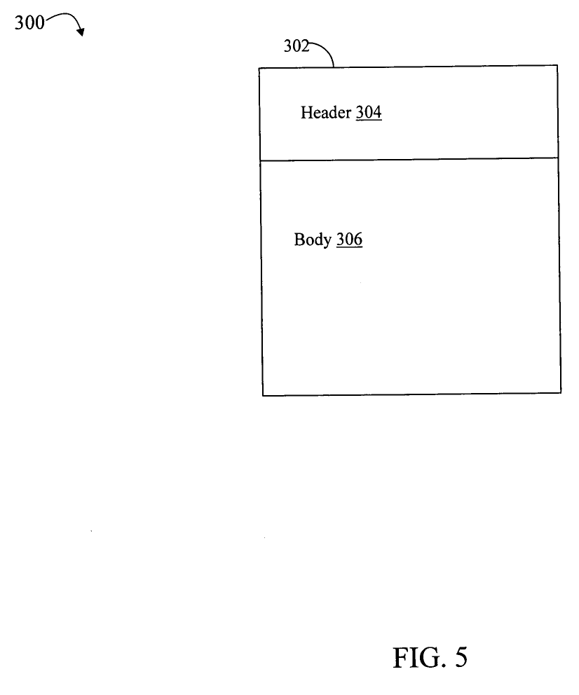

Referring now to FIG. 5, shown is an example of an embodiment of an incoming request. In this example, the request 302 is illustrated as including a header portion 304 and a body portion 306. The particular information included in the portions 304 and 306 may vary in accordance with the service or application to which the request is directed, the communication protocol, and the like. For example, in one embodiment, the request 302 may be in accordance with the HTTP protocol and associated request format.

The techniques described herein analyze attributes included in the header portion and/or the body portion. The particular attributes analyzed may vary with services and tasks performed by the server computer. Additionally, the possible values for these attributes and associated threat ratings may also vary with each server computer and the services performed therein. This is described in more detail in following paragraphs.

In one embodiment, the threat rating assigned to an incoming request is a numeric value providing a metric rating of the assessed threat potential of the incoming request. The threat rating represents an aggregate rating determined in accordance with one or more attribute values of the request. Analysis is performed on the request in a local or isolated context of the single request. Additionally, analysis is performed on the request from a global perspective of multiple incoming requests received by the server computer. In other words, a global traffic analysis may be performed on the incoming request. The threat profiles used in determining the threat rating include information in accordance with both the local and global analysis.

In connection with performing a local or isolated assessment of an incoming request, a determination may be made whether the request includes certain attributes. For example, an incoming request may be a query request for a search engine on the server computer. The incoming request may be examined to determine if particular query terms are included in the request. A first threat profile may include information about a request attribute corresponding to the query terms and particular values for the terms which are deemed to be harmful or pose a potential threat. The incoming request may also be analyzed in a global context with respect to other incoming requests received on the server computer. A threat profile may be maintained which associates a threat level with a particular IP address in which the IP address is the originator of the incoming request. The threat level may be based on the frequency of requests received from the particular IP address. The threat level may be based on a threshold level of requests received within a predetermined time period. Examples of particular attributes, the threat profiles and threat matrix will now be described.

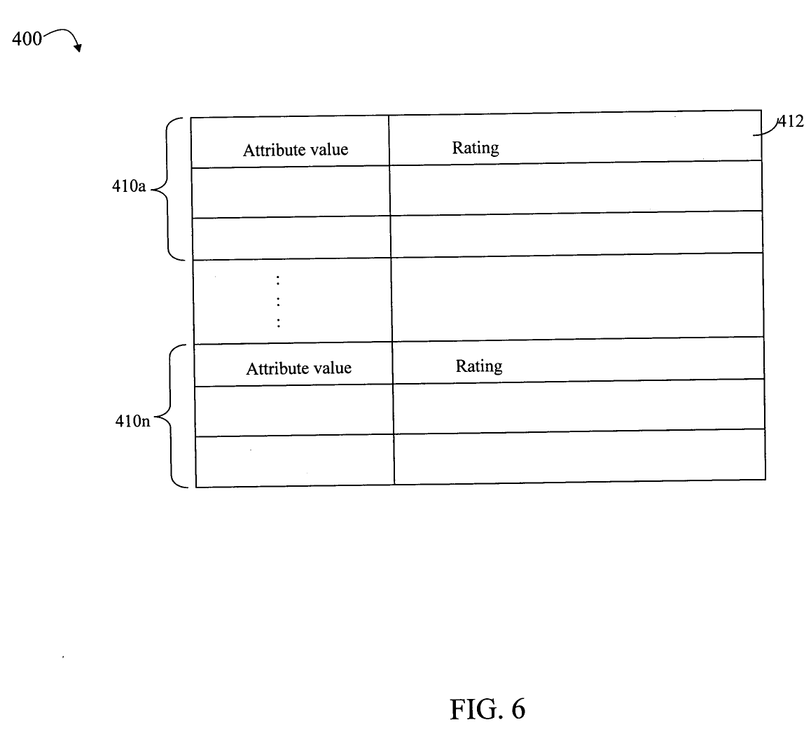

Referring now to FIG. 6, shown is an example of an embodiment of one or more threat profiles that may be included in an embodiment. The example 400 includes one or more tables. Each table may correspond to a threat profile for a particular attribute to be analyzed. The example 400 includes n tables 400a through 400n. Each table includes one or more rows 412. Each row of information includes an attribute value and an associated rating for when the attribute being analyzed from an incoming request has the attribute value.

In an embodiment, the threat profiles may be static and/or dynamic. The information in one or more of the threat profiles may be static in that it is not updated during operation server system in accordance with incoming request analysis. For example, a threat profile may be initialized to a set of attributes values and associated ratings. Each of the ratings may be characterized as static in which an initial value is assigned. The rating may remain at that value and is not modified in accordance with any analysis of incoming requests. The ratings may alternatively be characterized as dynamic in which the rating may be updated in accordance with incoming requests received on the server computer over time. Besides the ratings being static or dynamic, the attribute values may also be characterized as static or dynamic. For example, in one embodiment, a threat profile may be characterized as static in which there are a fixed set of attribute values. A threat profile may also have attribute values which are dynamically determined during runtime of the request analyzer.

As an example of a threat profile in which both the attribute values and ratings may be dynamic, consider a threat profile in which the attribute is associated with the IP address of the incoming request originator or sender. A threat profile may be maintained for incoming IP addresses over a time period determined to be a threat in accordance with a received number of incoming requests over a predetermined time period. Different configurable threshold levels may be associated with different ratings based on number of requests and/or an associated time period. Initially, the IP address sending a request may not be included in the threat profile at all. Once a threshold number of requests have been received by the server, the IP address may be added to the threat profile attribute value column. The associated threat rating for the attribute value may vary in accordance with the number of requests received during a specified time period. Accordingly, the associated rating for the IP address may change as the threat profiles are updated for each specified time period. Additional examples of attributes are described in more detail herein.

In an embodiment described in herein, the request analyzer (e.g., 102 of FIG. 3 and 202 of FIG. 4) may include a plurality of components. An incoming request may be analyzed using a first component, an incoming request analyzer, included in the request analyzer. The incoming request analyzer may perform the analysis of the incoming request using information currently included in one or more threat profiles in order to assign an overall threat rating to the incoming request. Another component, the global request analyzer, also included in the request analyzer, may perform updating of any dynamic portions of the threat profiles in accordance with multiple requests received over time. Thus, all or a portion of the threat profiles may be dynamically maintained in accordance with incoming requests received at the server computer. Those threat profiles, or portions thereof, designated as static may not be updated by the global request analyzer.

What will now be described are examples of attributes that may be analyzed by the request analyzer. It should be noted that an embodiment may analyze one or more of these attributes alone, or in combination with, other attributes not described herein. The attributes of an incoming request that may be parsed and analyzed include, for example, the request parameters, an IP address originating the incoming request, a user agent type, a destination URL or domain, the entry point or HTTP referrer, cookie, region or location designation of an incoming request, and a network or ASN (Autonomous System Number).

The request parameters and particular values may vary with the particular service being requested. For example, if an incoming request is a query request for a search engine, the parameters may include query terms. The parameter values and use may be different, for example, if the request is for a mail service. An elevated threat rating may be associated when an incoming request includes request parameters of a particular value known to be associated with potential threats. In connection with query terms, an elevated threat rating may be associated with an incoming request containing, for example, the same query strings multiple times, query terms which may be detected as nonsense query terms (e.g., unrecognized word, unexpected characters, etc.).

In connection with an IP address originating an incoming request, if a frequency or total number of requests received from a particular IP address is determined to be above a threshold volume, an elevated threat rating may be associated with all incoming requests having this IP address. It should be noted that this frequency may also be determined with respect to a particular time period (e.g., a threshold number of requests per second). An embodiment may also have more than one threshold and more than one threat rating. As the actual number of requests varies in accordance with the one or more specified thresholds, the threat rating associated with the IP address also varies.

Also in connection with an IP address originating an incoming request, an elevated threat rating may be associated with the incoming request if a threshold number of errors are generated in connection with servicing requests from the IP address over a time period. For example, if a threshold number of file not found errors are generated in connection with servicing request from a particular IP address, then an elevated threat level may be associated with the particular IP address.

Note that a first threat profile may be maintained for the frequency of requests associated with particular IP addresses sending requests and a second different threat profile may be maintained for the types and/or number of errors associated with particular IP addresses sending requests. In connection with the foregoing two threat profiles, the attribute values both specify IP addresses. However, the threat rating associated with each IP address in each profile is determined in accordance with different criteria (e.g., first threat profile based on frequency or number of requests per IP address, and second threat profile based on type and/or number of errors per IP address).

A threat profile may also be maintained for IP addresses so that any incoming request originating from this IP address, without more, is assigned an elevated threat rating. For example, requests originating from IP addresses known for sending spam requests (e.g., unsolicited messages having substantially identical content) may be assigned an elevated threat rating.

The user agent type includes information about the user agent originating the request. A user agent may be, for example, a particular web browser such as Internet Explorer™, Netscape, Mozilla, and the like. A user agent may also designate a particular scripting language, for example such as Perl, if the request was generated using this language. If a user agent is not an expected agent, such as a well-known web browser, an elevated threat rating may be associated with the incoming request including an attribute having such a value. If a user agent is, for example, a scripting language such as Perl, an elevated threat rating may be associated with the request since such scripts generating requests may be known to have a high probability of harm.

A destination URL or domain may be specified in a request for a specific file, DLL, and the like. In the event that a particular file, such as a DLL, is included in an incoming request, an elevated threat rating may be associated with the incoming request. It may be determined that requests for the existence of certain files or HTML pages may checking for the existence or availability of particular files that may be used, for example, in connection with an attack. For example, a first set of malicious code may be included in a particular file placed on a system at a first point in time. At a later point in time, other malicious code may attempt to locate and execute the first set of malicious code. The request for a particular HTML page, file, and the like, which is unexpected may flagged as a suspicious request and associated with an elevated threat rating. The particular threat rating may vary with the particular file requested, for example, if a particular file is known to be associated with malicious code.

In connection with HTTP requests, an entry point or HTTP referrer attribute identifies the last URL or site visited by a requesting user. For example, a user may visit various websites and then issue a request to the server. The address associated with the last website the user visited is identified as the entry point or HTTP referrer attribute in an incoming request. If the referrer attribute of a request identifies an invalid or undefined referrer (e.g., invalid URL), an elevated threat rating may be assigned to the incoming request.

An incoming request from a particular region or geographic origin may be assigned an elevated threat rating. For example, a known virus or other malicious code may originate requests from a particular region. It may also be determined that requests coming from a particular region are unexpected, or may otherwise be known to have a high probability of harm associated therewith. Accordingly, such requests may be assigned an elevated threat level that may vary in accordance with the region. The region may be determined, for example, based on the IP address of the originator. For example, the IP address sending or originating the incoming request may be from a specific country (e.g., www.myloc.uk=UK is the country designation).

In addition to having threat profiles for attribute values which may be explicitly included in the incoming request, an embodiment may include one or more threat profiles for attributes that may be characterized as derived attributes. Derived attributes may be defined as attributes determined indirectly using one or more other request attributes. Using the IP address sending the request, additional information may also be determined. For example, the IP address may be used to determine the ASN (Autonomous System Number) associated with the incoming request. As known in the art, ASNs are globally unique identifiers for Autonomous Systems. An Autonomous System (AS) is a group of IP networks having a single clearly defined routing policy, run by one or more network operators. Requests associated with certain ASNs may be assigned an elevated threat rating. The foregoing use of ASNs may be used to determine from where a request originates. It may be that requests originating from certain ASNs are known to be associated with malicious code. For example, it may be that requests coming from specific countries are known to have a high occurrence of being associated with a malicious attack. The particular country may be determined using the ASN associated with a request.

Certain other request properties may also be associated with an elevated threat level. If cookies are disable in connection with an incoming request, this may indicate that a user agent of the request which wants to remain discrete. If an incoming request has cookies disabled, the incoming request may be assigned a higher threat level for this particular setting than incoming requests having cookies enabled.

If a message header of an incoming request is larger than an expected size or threshold, the incoming request may be nefarious indicating an elevated threat rating. The packet header size may be large enough to causes problems on the receiving system. It may be that the larger the packet header size over a certain threshold value, the large the assigned threat rating

The foregoing attributes may be determined through parsing of an HTTP request header and body in an embodiment. It should be noted that not all requests may include all of the foregoing attributes. In other words, some of the attributes may be optionally specified in accordance with the particular request format as well as services performed by the server.

In addition to the foregoing attributes, other attributes may also be monitored and have associated threat ratings in threat profiles in accordance with an associated threat level. An embodiment may also monitor one or more of the following attributes in connection with received requests as described herein in connection with determining a threat rating.
Source Port—If a user is coming from a port other than 80 or port 443, the user may be automating the call which could be an indication of the attack. Use of a port other than one of the foregoing or other expected ports may be associated with an elevated threat rating.
via or X-Forwarded-For—(For proxy calls) The foregoing attribute lists proxy information that may include an IP that has been blocked. The use of the foregoing proxy information including a blocked IP address may be used in connection with an attacker attempting to obscure an attack and may be associated with an elevated threat rating.
Destination Port—A destination port of an IP destination may typically be, for example, 80 or 443 for http requests. If the destination port is other than one of the foregoing or other expected typical values, it may indicate an attack and may be associated with an elevated threat rating.
Protocol—This attribute indicate the protocol for the request (e.g. http/1.1, http/1.0) If a protocol is not specified, this may be an indication of a script associated with an attack and may be associated with an elevated threat rating.
Request Method—This attribute indicates the method of request (e.g., get, post). If the method indicates a particular value, such as post, this may be an indicator of an end user trying to submit something to the server. If the request method is, for example, post, the request may be associated with an elevated threat rating since such methods may be known to be more to attack sequences than other request methods.
Data—If the request method is post, this field will have data included. The data in this field could be the indicator of a problem and may indicate an elevated threat rating.
Accept—This attribute defines the preferred content type (e.g., .gif, .jpg, etc) for the server. If the accept attribute value is different from what the server prefers to accept, it may be an indication of an attack and may be associated with an elevated threat rating.
Accept-Language—This attributed defines the language for the browser issuing the request and may indicate the country of origin for the call. As described elsewhere herein it may be known that particular countries may be associated with a higher level of attacks than others. Particular countries may be associated with an elevated threat level.
Connection—This attribute may be used in connection with optimizing the connection between browser and server. This attribute may be used to specify a value used to keep a thread with the client open for an extended length of time. If this value is more than a specified time, the browser may consume more server resources and may cause a server failure due to no available resources. A value associated with a time larger than a threshold may be associated with an elevated threat level.
Keep-Alive—This attribute may be used to keep a connection to a page alive for a specified amount of time and may cause issues as described above for the connection attribute.
Pragma—This attribute may be used in connection with controlling the caching of content on web page (i.e., server control). This attribute is not likely to be used directly in a request. Thus, use of this in a request may be associated with an elevated threat rating.
Cache-Control—This attribute controls caching of content for the web page (i.e., server control). This attribute is not likely to be used directly in a request. Thus, use of this in a request may be associated with an elevated threat rating.
If Modified Since (IMS)—This attribute may be used to indicate whether to perform a cache refresh by the server of the requesting client. A user may be able to overwhelm a server with a series of IMS calls which may consume server resources. Requests may be monitored for IMS values exceeding a threshold level (e.g., as an absolute value, within a specified time period, and the like) which may indicate an attack and be associated with an elevated threat level.
Username—This attribute specifies the user name and may be used for authentication. Not likely used directly. This attribute is not likely to be used directly in a request. Thus, use of this in a request may be associated with an elevated threat rating.

It should be noted that attributes described herein may be included in the host header portion of an HTTP request as described, for example, in RFC 2616 regarding HTTP 1.1. Other request formats and attributes may also be used in connection with the techniques described herein.

In connection with determining an overall threat rating for an incoming request, an embodiment may add the threat ratings associated with the various attributes analyzed. For example, if 3 attributes are included in an incoming request and are analyzed as attributes of interest in incoming requests for a particular service, 3 threat ratings may be determined. The overall threat rating associated with the incoming request may be determined by adding the 3 threat ratings.

It should be noted that a threat profile as illustrated in the example 400 of FIG. 6 may include a single attribute value as well as multiple attribute values. The occurrence of a first attribute value for a first attribute may have a first threat rating. The occurrence of a second attribute value for a second attribute may have a second threat rating. If the incoming request includes both of these attribute values in combination, an embodiment may assign a higher threat rating to the request than may result by adding the first and second threat ratings. As such, an embodiment may include a threat profile for the individual attribute values and then an additional threat profile for groupings of multiple attribute values which may be deemed a greater threat or warrant a higher threat rating when they occur in combination in a same request. Such examples may include, for example, a particular user agent and region or geographic origin of an incoming request, particular query terms and IP addresses, and the like. To determine the overall threat rating or score associated with the request, the threat ratings associated with each attribute may be added. Additionally, a bonus value as may be determined based on the combination of the two or more particular attributes may also be added in determining the overall threat rating for the request. For example, a request having a useragent attribute=attribute1 may be determined using a first threat profile to have an associated rating of 5. The request also having an ASN attribute=Russia may have an associated rating of 3. For having the combination of the foregoing in the same request, a bonus value of 3 may be added to the request'score so that the overall threat rating for the request is 11. In an embodiment, if the maximum possible score is 20, the foregoing indicates a higher than 50% threat rating based on the maximum possible score

It should be noted that the threat ratings and any associated thresholds with one or more of the foregoing may also be user configurable in an embodiment. The particular threat profiles may be determined in a variety of different ways and may vary with each server system. In one embodiment, the threat profiles and an initial set of threat values may be determined by examining and analyzing request logs over a time period. Through such empirical analysis, a threat rating may be determined. It should be noted that if an embodiment includes threat ratings of different scales or ranges, different techniques may be used in connection with normalizing the threat ratings in connection with determining a collective or overall rating for an incoming request in accordance with all analyzed attributes.

Once the threat rating for an incoming request is determined, a threat matrix may be used in connection with determining an appropriate action to take.

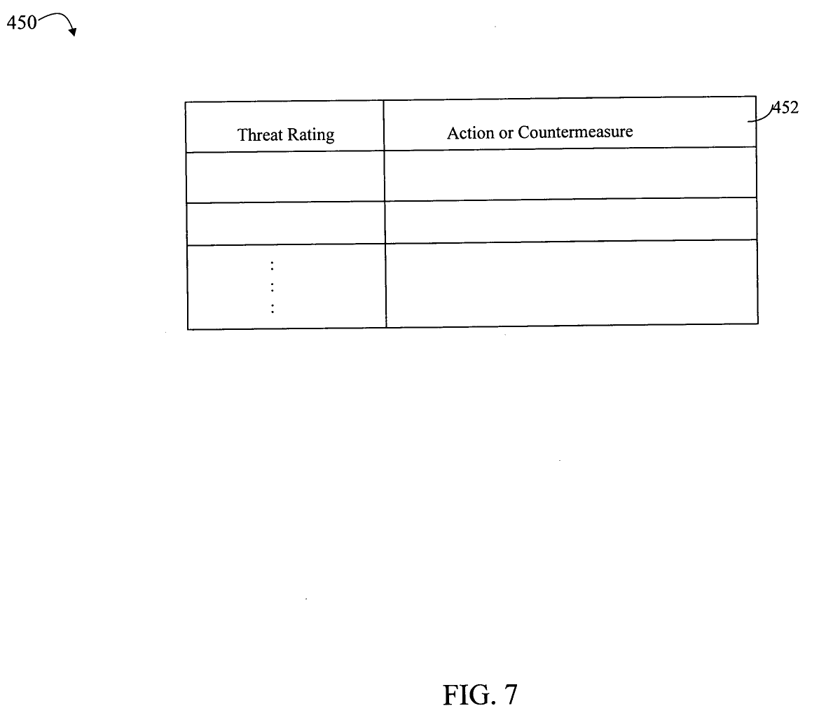

Referring now to FIG. 7, shown is an example of an embodiment of a threat matrix. A threat matrix includes a defined set of actions to take based on the threat potential as determined in accordance with the threat rating. The example 450 includes a table of records or rows. Each record or row, such as 452, includes a threat rating and an associated action or countermeasure. The threat rating may specify a single value or a range of values. In one embodiment, four following actions or countermeasures may be defined for four different ranges of threat ratings—high, moderate, low, and no threat. As described in following sentences, the first action is associated with the highest threat rating (e.g., high designation) and the fourth or last action is associated with the lowest threat rating (e.g., no threat). A first action of blocking access or denying any service in connection with the incoming request may be determined for a highest level of threat rating. Such action may be specified, for example, if there is a very high probability that harm may result if the incoming request is serviced. A second action may be associated with a slightly reduced or moderate threat rating. In one embodiment, this action causes an HTTP redirection of the incoming request. In such a redirection, the request may be performed by an alternate site and may be carefully monitored to as not to result in comprising of the server system. A third action may be associated with a low threat rating in which the request is serviced but monitored. In other words, additional recording of resulting activities on the server may be performed. Such recording may include, for example, auditing or logging additional details in connection with servicing the request. A fourth action may be associated with a determination of no threat rating in which there is a determination or assessment using the techniques described herein that no threat exists with servicing the incoming request. Accordingly, the fourth action allows the request to be serviced at the server system without any additional monitoring.

The particular number and countermeasures or actions may vary with each embodiment. The specified countermeasure may also be user configurable.

The particular threat ratings and associated actions as well as the threat ratings of the threat profiles in an embodiment may be tuned in accordance with the particular incoming request traffic in the embodiment. Similarly, any thresholds utilized may also be selected in accordance with the particular traffic and services of each server.

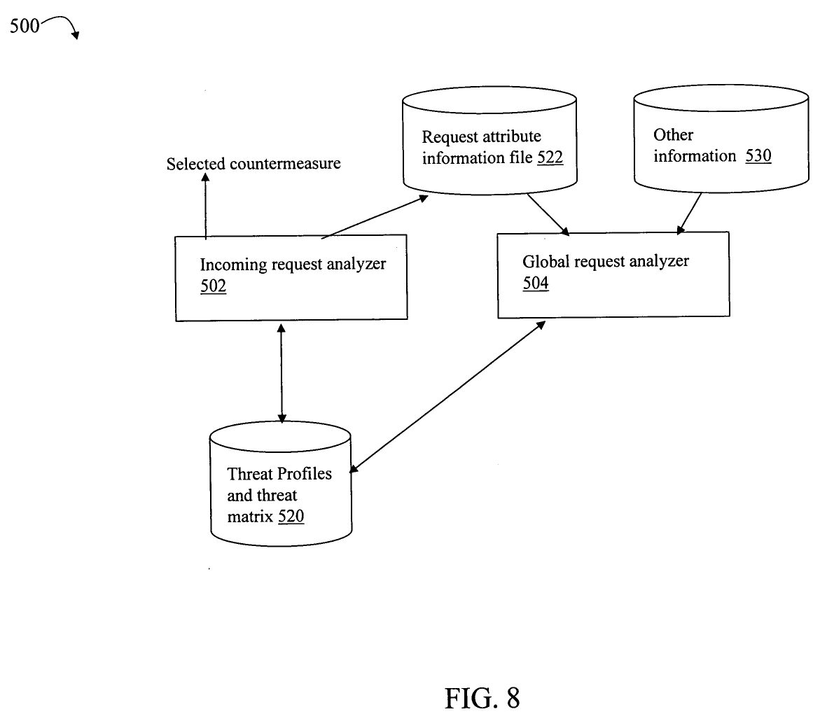

Referring now to FIG. 8, shown is an example of components that may be included in an embodiment of a request analyzer. The request analyzer is illustrated as element 102 of FIG. 3 and element 202 of FIG. 4. The example 500 includes an incoming request analyzer 502 which analyzes the incoming request, assigns a threat rating using the threat profiles of 520, and determines a selected countermeasure using the threat matrix of 520. The selected countermeasure or action determined may be an input to another component, such as the firewall, to perform processing with the associated action. It should be noted that the components of 500 perform the selection process and, in the embodiment described herein, interact with other components to perform the associated action.

The incoming request analyzer 502 may also output attribute information of analyzed requests to the request attribute information file 522. Such information may include the particular attribute and values of each incoming request. The information in 522 may be used in connection with performing a collective analysis or global analysis of incoming requests received by the server computer. In one embodiment, the incoming request analyzer 502 may write the attribute information to the file 522. When the file 522 reaches a particular size, or a predetermined amount of time has passed, an analysis of the file 522 may be performed by the global request analyzer 504. The information in 522 is processed by 504. Once processed, the information in 522 is flushed or deleted.

The global request analyzer 504 may perform processing for monitoring attribute values over time for all incoming requests and perform trending to update threat profiles, or portions thereof, designated as dynamic. In other words, if a threat profile has a fixed or static set of attribute values, the associated threat ratings may be assigned an initial value which is dynamically adjusted in accordance with the analysis performed by 504 over all incoming requests. As also described herein, both the attribute value and associated threat rating information in a threat profile may be dynamically determined based on analysis performed by 504. Other information 530 may also be input to 504. Such other information may include, for example, information identifying profile characteristics of known sources of potential threats. For example, as new malicious code is profiled, certain characteristics may be input as represented by 530 to the global request analyzer 504. The component 504 may then analyze the information in 522 to flag requests accordingly. For example, a request for a particular destination URL or file may automatically cause an elevated threat rating. However, an even higher threat rating may be associated with requests for known URLS or files associated with known malicious code. The processing performed by 504 may be characterized as providing feedback into the system described herein in accordance with collective analysis of the incoming requests.

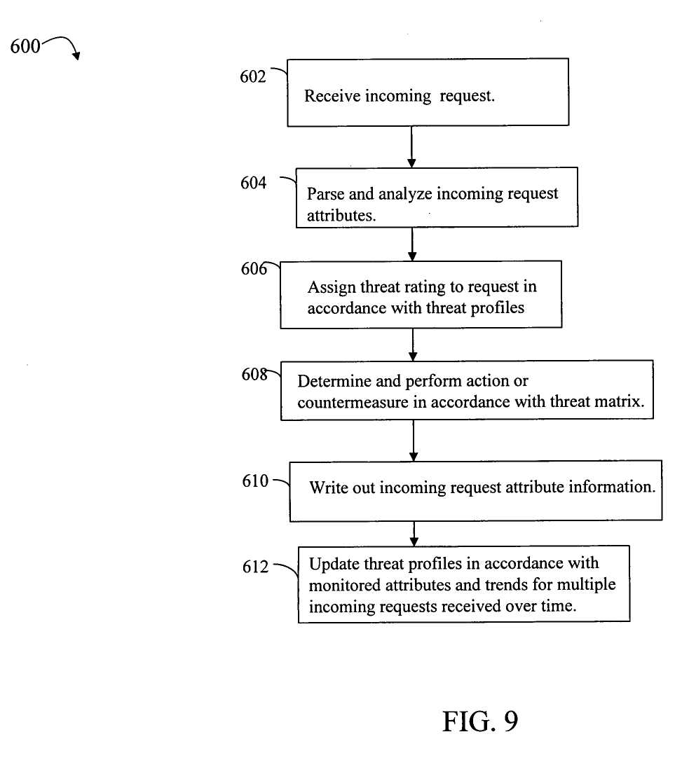

Referring now to FIG. 9, shown is a flowchart of processing steps that may be performed in connection with an embodiment in connection with the techniques described herein. The steps of flowchart 600 summarize processing described herein in connection with identifying and managing potentially harmful incoming requests. It should be noted that prior to execution of flowchart 600, the components such as illustrated in FIG. 8 of the server system are running and a set of threat profiles may be initially defined. However, it should be noted that certain threat profiles, such as those identifying IP addresses associated with a high volume of incoming request, may not initially contain any information. At step 602, an incoming request is received. At step 604, the incoming request is parsed and analyzed. The attributes of interest in accordance with the particular embodiment may be extracted from the incoming request. At step 606, threat ratings are determined for each of the attributes of interest using the appropriate threat profiles. An overall threat rating is associated with the request in accordance with the individual threat ratings for the request attributes. At step 608, an action or countermeasure is determined and performed for the request threat rating as defined in the threat matrix. At step 610, the incoming request attribute information may be recorded, as in the file 522, for follow-on processing. At step 612, the threat profiles are updated in accordance with the monitored attributes and trends for multiple incoming requests received over time. The processing of step 612 may be performed by component 504 of FIG. 8. Steps 602, 604, 606, 608, and 610 may be performed for each incoming request and step 612 may be performed in accordance with the particular trigger conditions defined in an embodiment. As described herein, such trigger conditions causing component 504 to analyze the information in 522 may include a specified threshold size of the file 522, and/or a predetermined time interval from which the last time 504 performed the analysis of the file 522 and updated the dynamic information in the threat profiles.

It should be noted that in connection with the embodiment described herein, the portions of the incoming requests which may be analyzed using the techniques described herein may characterized as those portions which may be processed by any one or more layers of the OSI (Open Systems Interconnection) model. As will be appreciated by those skilled in the art, the OSI model includes seven layers: the application level (highest level—layer 7), the presentation layer (layer 6), the session layer (layer 5), the transport layer (layer 4), the network layer (layer 3) the data link layer (layer 2), and the physical layer (layer 1—the lowest layer). In the embodiment described herein, one or more of the parameters and other attributes included an incoming request may be analyzed by the request analyzer in which the attributes may be consumed or utilized by any one or more of the foregoing OSI layers. This is in contrast, for example, to application level filtering or firewall filtering in which an analysis and decision of whether to block a request is not based on information which may be used or consumed by one or more of the foregoing layers.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of identifying a potentially harmful request comprising:
assigning a threat rating to a received request in accordance with one or more attribute values of said received request; and
determining an action in accordance with said threat rating.

2. The method of claim 1, further comprising:
performing said action.

3. The method of claim 1, wherein said action indicates whether processing associated with servicing said received request is performed.

4. The method of claim 1, wherein said threat rating is an overall threat rating for said received request, and the method further comprising:
determining an individual threat rating for each of said one or more attribute values.

5. The method of claim 1, wherein said threat rating is an overall threat rating for said received request, said assigning is performed using a plurality of attributes of said received request, and the method further comprising:
determining an individual threat rating for a plurality of said attribute values occurring within a same request.

6. The method of claim 4, further comprising:
adding each of said individual threat ratings to determine said overall threat rating.

7. The method of claim 1, wherein said threat rating is determined using at least one derived attribute value generated using one or more attribute values included in said received request.

8. The method of claim 1, further comprising:
receiving one or more threat profiles, each of said one or more threat profiles identifying threat levels for specific attribute values.

9. The method of claim 8, wherein said assigning step determines a threat rating for one or more attribute values included in said received request using appropriate ones of said threat profiles.

10. The method of claim 1, wherein said determining step uses a threat matrix identifying one or more actions to take in accordance with associate threat ratings.

11. The method of claim 10, wherein said threat matrix includes a plurality of ranges of threat ratings, each of said ranges being associated with an action.

12. The method of claim 1, wherein said assigning and said determining are performed by a request analyzer associated with a firewall component on a system receiving the received request.

13. The method of claim 8, wherein one or more of said threat profiles include information which is dynamically determined in accordance with a trending of received requests over period of time.

14. The method of claim 13, wherein said trending is performed in accordance with predetermined criteria including at least one of: a size associated with incoming requests received over a time period, and a predetermined amount of time from when said trending was last performed.

15. The method of claim 8, wherein a first threat rating is associated with a first threshold for one of said attribute values and a second threat rating is associated with a second threshold for said one of said attribute values.

16. A method of identifying a potentially harmful request comprising:
receiving one or more threat profiles identifying threat ratings for associated attribute values included in incoming request;
tagging an incoming request with a request threat rating in accordance with one or more attribute values of said incoming request; and
determining an action in accordance with said request threat rating.

17. The method of claim 16, further comprising:
determining said request threat rating by adding a plurality of said threat ratings for attributes values associated with said incoming request.

18. The method of claim 16, wherein a portion of information included in said threat profiles is dynamically determined in accordance with a trending of received requests over period of time.

19. A computer readable medium having computer executable instructions stored thereon for performing steps comprising:
receiving one or more threat profiles identifying threat ratings for associated attribute values included in incoming request;
tagging an incoming request with a request threat rating in accordance with one or more attribute values of said incoming request;
determining an action in accordance with said request threat rating; and
performing said action.

20. The computer readable medium of claim 19, further comprising executable instructions stored thereon for performing steps comprising:
dynamically determining at least a portion of information included in said threat profiles in accordance with a trending of received requests over period of time.
